(19) United States
(12) Patent Application Publication
(10) Pub. No.: US 2018/0294550 A1
(43) Pub. Date: Oct. 11, 2018

(54) ANTENNA ELEMENT PREFERABLY FOR A BASE STATION ANTENNA

(71) Applicant: HUAWEI TECHNOLOGIES CO., LTD., Shenzhen (CN)

(72) Inventors: Juan SEGADOR ALVAREZ, Munich (DE); Nadine PFUHL, Munich (DE); Bernhard RIST, Munich (DE); Bruno BISCONTINI, Munich (DE); Johann Baptist OBERMAIER, Munich (DE); Susanne SCHILLIGER KILDAL, Munich (DE); Rene HERSCHMANN, Munich (DE)

(21) Appl. No.: 15/968,845

(22) Filed: May 2, 2018

Related U.S. Application Data
(63) Continuation of application No. PCT/EP2016/075779, filed on Oct. 26, 2016.

(30) Foreign Application Priority Data
Nov. 3, 2015 (EP) EP15192679.7
Dec. 21, 2015 (EP) EP15201607.7

(51) Int. Cl. H01Q 1/24; H01Q 21/26; H01Q 13/18; H01Q 9/28; H01Q 19/10; H01Q 21/06

(52) U.S. Cl. CPC H01Q 1/246; H01Q 21/26; H01Q 21/062; H01Q 9/28; H01Q 19/108; H01Q 13/18

(57) ABSTRACT

The present invention discloses an antenna element preferably for a base station antenna. The antenna element comprises: a support structure being a single part and comprising a foot, a top and a wall connecting the foot to the top, the wall surrounding a hollow area; a first metallization arranged on a first surface area of the support structure, the first metallization forming at least a first radiating element extending along the wall from the foot to the top; and a second metallization arranged on a second surface area of the support structure, the second metallization forming at least a first feeding circuit for the first radiating element.

### CROSS-REFERENCE TO RELATED APPLICATIONS

This application is a continuation of International Application No. PCT/EP2016/075779, filed on Oct. 26, 2016, which claims priority to European Patent Application No. EP15201607.7, filed on Dec. 21, 2015, and European Patent Application No. EP15192679.7, filed on Nov. 3, 2015. All of the aforementioned patent applications are hereby incorporated by reference in their entireties.

### TECHNICAL FIELD

The present invention relates to the field of antennas, and in particular to an antenna element for base station.

### BACKGROUND

Antennas for base stations used in mobile communication networks are typically array antennas which consist of several dipoles (radiators) in a cross configuration in order to generate a +45° and −45° polarization. For the production of such dipoles, different technologies are commonly used. Conventional solutions have die casted radiators in combination with additional plastic parts or etched planar radiators which consist of several planar substrates (PCBs) and additional plastic parts.

Commonly the radiator production is characterized by several time consuming production steps. These are for example:
Alignment of the parts.
Soldering the radiator parts together for providing electrical contact.
Assembly of additional plastic parts due to mechanical (stability) or electrical (matching and pattern correction) reasons.

Due to the fact that a radiator consists of several parts, the assembly costs are relevant for the overall production costs of an antenna.

The reliability of the antenna suffers from the complex structure and the difficult production process.

### SUMMARY

It is an object of the invention to provide an antenna element having improved reliability and reduced assembly cost.

According to a first aspect, an embodiment of the present invention provides an antenna element preferably for a base station antenna, including:

a support structure being a single part and comprising a foot, a top and a wall connecting the foot to the top, the wall surrounding a hollow area;

a first metallization arranged on a first surface area of the support structure, the first metallization forming at least a first radiating element extending along the wall from the foot to the top;

a second metallization arranged on a second surface area of the support structure, the second metallization forming at least a first feeding circuit for the first radiating element;

wherein the first surface area of the support structure and the second surface area of the support structure are arranged opposite to each other, and wherein either the first surface area or the second surface area is adjacent to the hollow area.

In a first possible implementation manner of the first aspect, the antenna element further comprises at least a first and a second non-conducting slot on the surface area in the first metallization, the slots extending in a direction from the foot to the top. To achieve optimal performance the slots can be evenly distributed in the first metallization. Hence, a distance between slots is the same if measuring clockwise or counter-clockwise along the wall. This may also be true for higher number of slots. For a higher number of slots, the distance between different neighboring slots should also be equal.

With reference to any one of the foregoing implementation manners of the first aspect, in a second possible implementation manner of the first aspect, the first feeding circuit comprises on the second surface area a first microstrip line crossing the first slot and a second microstrip line crossing the second slot.

With reference to any one of the foregoing implementation manners of the first aspect, in a third possible implementation manner of the first aspect, on the first surface area between the slots in the first metallization, the first metallization is solid or continuous.

With reference to the third implementation manner of the first aspect, in a fourth possible implementation manner of the first aspect, further non-conducting areas are arranged on the first surface area between the slots in the first metallization.

With reference to any one of the foregoing implementation manners of the first aspect, in a fifth possible implementation manner of the first aspect, the support structure further comprises a third surface area surrounding the hollow area and extending in an orthogonal direction compared to an extension direction of the wall between the foot and the top, and the first metallization further extends along the third surface area.

With reference to the fifth implementation manner of the first aspect, in a sixth possible implementation manner of the first aspect, the third surface area has a larger outer circumference than the wall.

With reference to any one of the foregoing implementation manners of the first aspect, in a seventh possible implementation manner of the first aspect, the antenna element further comprises on the support structure an electrically closed ring and a non-conducting gap, wherein the electrically closed ring surrounds the first radiating element; and the non-conducting gap isolates the first radiating element and the electrically closed ring from each other. An electrically closed ring should be understood as a metallized ring which is for signals radiated by the antenna elements (i.e. having a certain frequency) conductive. Hence, the ring may be a continuously closed metal trace, but could also be consisting of several small metal elements arranged in a ring but having non-conducting gaps between them. The gaps are chosen such that for the signals radiated by the antenna element the ring is still conducting. Of course the ring does not necessarily need to be round, it could also be square, rectangular, elliptic, etc.

With reference to the seventh implementation manners of the first aspect, in a eighth possible implementation manner of the first aspect, the electrically closed ring is arranged on the third surface area.

With reference to the seventh implementation manners of the first aspect, in a ninth possible implementation manner of the first aspect, the support structure further comprises a fourth surface area surrounding the hollow area and extending from an edge of the third surface area distant from the wall in an extension direction of the wall between the top and the foot; wherein the electrically closed ring is arranged on the fourth surface area or on both the third surface area and the fourth surface area; and wherein the non-conducting gap is on the third surface area or the fourth surface area.

With reference to any one of the foregoing implementation manners of the first aspect, in a tenth possible implementation manner of the first aspect, the antenna element further comprises a director arranged at the top of the support structure.

With reference to the tenth implementation manners of the first aspect, in a eleventh possible implementation manner of the first aspect, the director and the support structure are formed in a single part.

With reference to any one of the foregoing implementation manners of the first aspect, in a twelfth possible implementation manner of the first aspect, the antenna element is a Molded Interconnect Device, MID.

With reference to any one of the foregoing implementation manners of the first aspect, in a thirteenth possible implementation manner of the first aspect, the antenna element further comprises a printed circuit board, PCB, comprising a first feeding line, a second feeding line and a power divider, wherein the first feeding circuit comprises at the foot of the support structure a first input port connected to the first feeding line and a second input port connected to the second feeding line, and wherein a length of the first feeding line on the PCB from the power divider to the first input port is equal to a length of the second feeding line on the PCB from the power divider to the second input port.

With reference to any one of the foregoing implementation manners of the first aspect, in a fourteenth possible implementation manner of the first aspect, the first metallization further forms a second radiating element and the second metallization further forms a second feeding circuit for the second radiating element, wherein the first radiating element has a first polarization and the second radiating element has a second polarization, wherein the first polarization and the second polarization are orthogonal to each other.

Due to the foregoing technical solution, assembly time is reduced and reliability is improved.

### BRIEF DESCRIPTION OF THE DRAWINGS

FIGS. 1a-1c are schematic structural views of a dual-polarized antenna element according to an embodiment of the present invention;

FIGS. 1d-1f are schematic structural views of a single-polarized antenna element according to an embodiment of the present invention;

FIG. 2 is schematic structural view of a dual-polarized antenna element with a director according to an embodiment of the present invention;

FIGS. 3a-3b further schematic structural view of a further dual-polarized antenna element with director;

FIGS. 4a-4e are schematic structural views of dual-polarized antenna elements with different electrically closed parasitic rings according to embodiments of the present invention;

FIGS. 5a-5c show in diagrams the return loss and radiation pattern of an antenna element with a parasitic ring according to an embodiment of the present invention;

FIGS. 6a-6c are schematic structural views of an antenna element with squared dipoles;

FIGS. 7a-7b show a feeding solution with crossing lines on the support structure of the antenna element;

FIG. 8 shows a feeding solution using a PCB.

### DESCRIPTION OF THE EMBODIMENTS

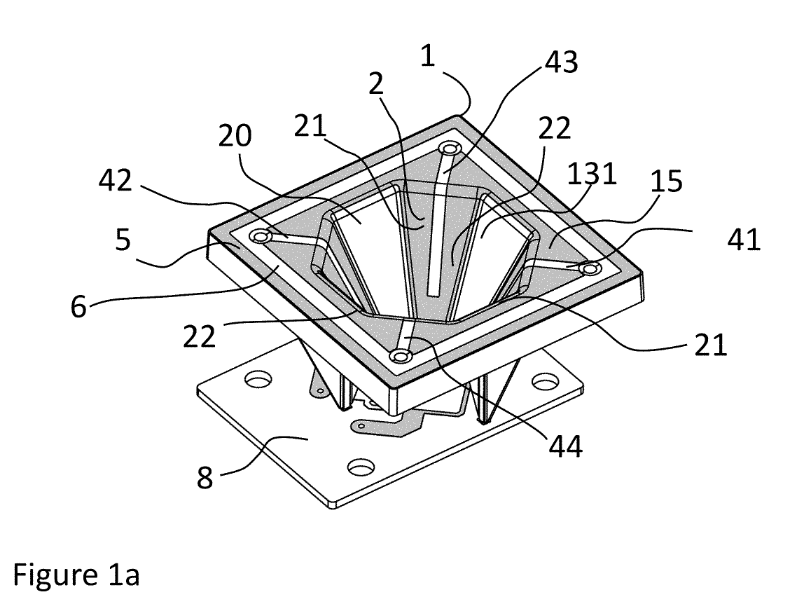

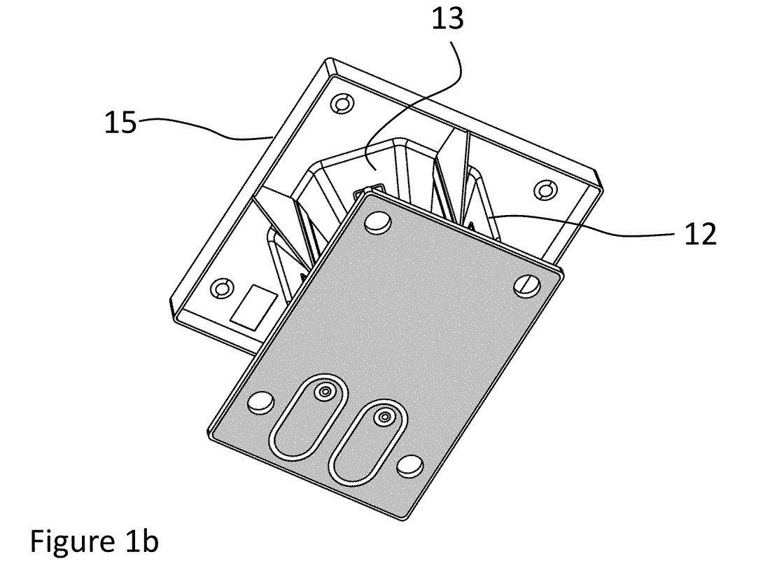

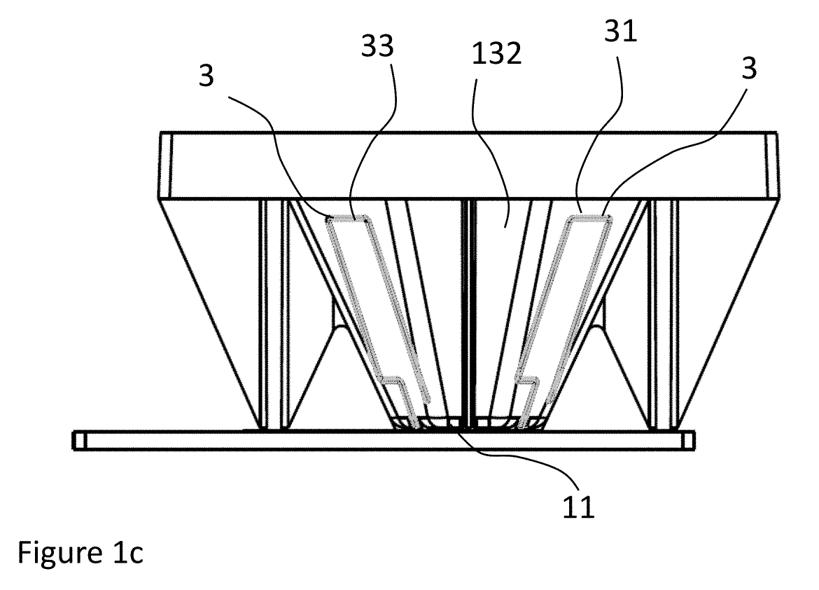

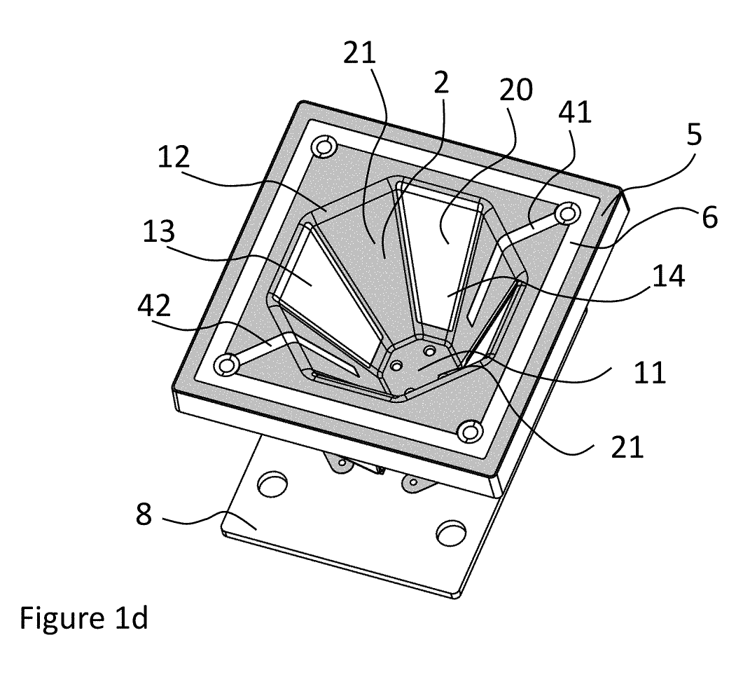

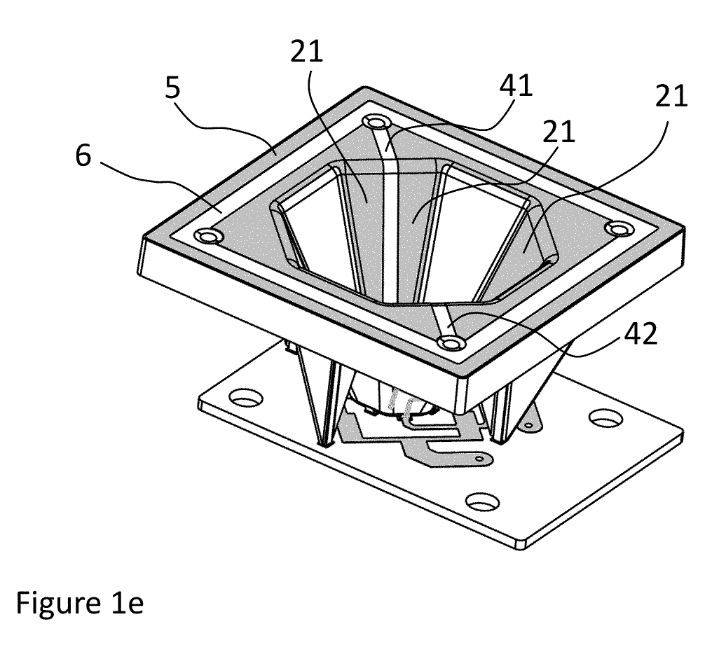

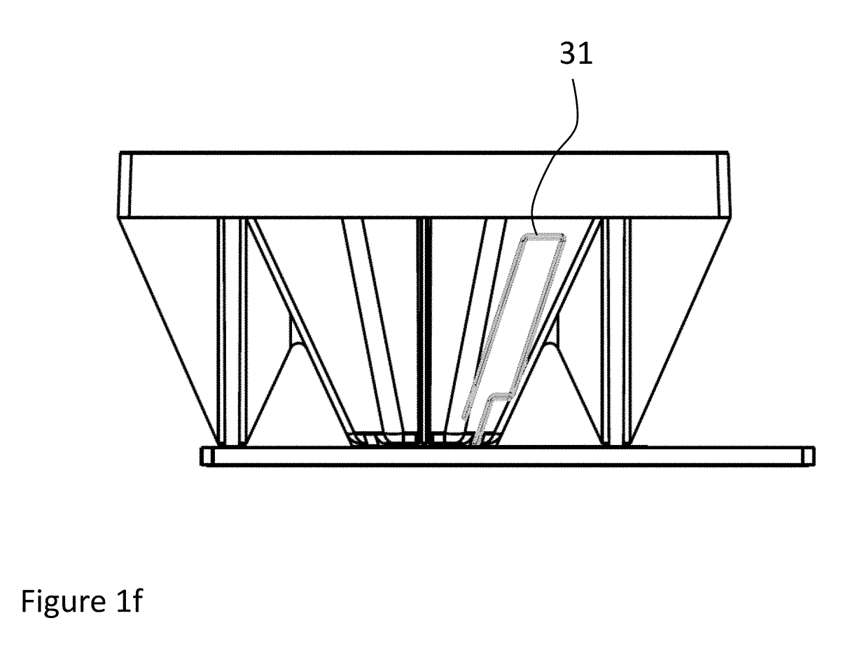

FIGS. 1a to 1f show an antenna element according to an embodiment of the present invention. Just for a better visibility in the FIGS. 1a to 1f metallized areas have light grey color. The radiating element comprises a (dielectric) support structure 1. The support structure 1 is a single part which comprises a foot 11, a top 12 and a wall 13. The (tube like) wall 13 connects the foot 11 to the top 12 and surrounds a hollow area 14. Furthermore, the antenna element comprises a first metallization 2 arranged on a first surface area 131 of the support structure 1. The first metallization 2 forms a first radiating element 21 and a second radiating element 22 extending along the wall 13 from the foot 11 to the top 12. Furthermore, the antenna element comprises a second metallization 3 arranged on a second surface area 132 of the support structure 1. The second metallization 3 forms a first feeding circuit 31 for the first radiating element 21 and a second feeding circuit 33 for the second radiating element 22. The first surface area 131 of the support structure 1 and the second surface area 132 of the support structure 1 are arranged opposite to each other. The first surface area 131 is arranged is adjacent to the hollow area 14. Or in other words, the radiating elements 21, 22 extend from the foot 11 to the top 12 on an inside area of the wall 13 and the feeding circuits 31, 33 are arranged on an outside are of the wall 13. In further embodiments, this arrangement may also be altered to have the feeding circuits on the inside area of the wall and the radiating elements on the outside area of the wall.

With the configuration of the integrated radiating elements 21-22 as shown on FIGS. 1a-1c the antenna element forms a squared dipole made out of one part. Squared dipoles are commonly used in base station antennas, because they provide higher gain compared to cross-dipoles. The radiating elements 21-22 are formed by adding non-conducting slots 41-44 to the first metallization 2 on the first (e.g. inner) surface area 131 of the dielectric support structure 1. In other words, the antenna element comprises four non-conducting slot 41-44 on the first surface area 131 in the first metallization 2. The slots 41-44 extend in a direction from the foot 11 to the top 12. In a solution with a single radiating element, two slots (e.g. slots 41, 42 or slots 43, 44) would be sufficient. The radiating elements 21-22 are then fed across the slots 41-44 by the feeding circuits 31-32 (formed by the second metallization 3) on the second (e.g. outer) surface area 132 opposing the first surface area 131 of the dielectric support structure 1.

A feeding circuit 31 or 32, could for example, comprise microstrip lines crossing the slots 41-42 or 43-44. As can be for example seen in FIG. 1c, the microstrip lines are arranged on the outside area of the wall 13, whereas the slots 41-44 are arranged on the inside area of the wall 13. The traces of the feeding circuits 31, 32 can be understood as microstrip lines as the first metallization 2 (arranged on the opposite side of the wall 13) is directly connected to ground. Hence, it can be seen that on the same dielectric supporting structure 1 which carries the radiating elements 21, 22, also the corresponding feed lines (as micro strip lines) are integrated.

Hence, antenna elements according to embodiments of the present invention combine the radiating elements 21-22, the mechanical body (i.e. the support structure 1) and the feeding network 31-32 of the radiating elements in only one mechanical part. Hence, embodiments provide an antenna element or radiator which consists only of one mechanical plastic part (dielectric carrier) which can be produced in a low cost molding process. The radiating elements (e.g. dipoles or dipole arrangement) and their feeding network are manufactured by metallization of the plastic part (the dielectric support structure 1). The element design can fulfill the requirements to be used in base station applications. A VSWR <1.35 over a bandwidth of 50% can be achieved.

Hence, one key aspect of embodiments of the present invention is that the complete antenna element can be produced as one single part as an MID (molded interconnect device).

In the following, some further (optional) features of embodiments of the present invention some further embodiments are described in more detail.

The radiating elements 21-22 are fed across the slots 41-44 by four baluns (balanced-unbalanced). Two baluns positioned on opposite sides of the antenna element (both on the outer surface area of the support structure 1) represent the same polarization and have to be combined. In the presented solution, this combining is done on the PCB 8. In this way, the array feeding network which provides signals in the classical ±45 degree configuration, can be established. The first metallization 2 forming the radiating elements 21-22 is connected to the ground plane of the PCB 8.

The embodiment shown in FIG. 1a uses a dipole body that has a “tube shape” in combination with a slot feeding concept. This concept allows the radiator structure (the radiating elements 21-22) to be on the (first) inner surface area 131 (FIG. 1a) and the feeding structure on the (second) outer surface area 132 (FIG. 1b) of the tube or wall 13 between the foot 11 and top 12 of the support structure 1, or vice-versa. This basic antenna structure can vary from round, squared, octagonal, hexagonal and also non symmetric tube shaped form. The metallized plastic body can be soldered to a PCB 8 (FIGS. 1a and 1c) which works as an interface to an antenna distribution network.

FIGS. 1a-1c show a dual-polarized implementation (e.g. having two dipoles or radiating elements 21-22) of the antenna element.

FIGS. 1d-1f show a possible implementation with only one polarization (e.g. having one dipole or radiating element 21).

Furthermore, in all embodiments shown an electrically closed (parasitic) ring 5 surrounding the radiating element(s) is present. Implementations with one polarization, without the ring 5, or with more than one polarization with a ring 5, are also possible.

The ring 5 is formed by a further metallization. A non-conducting gap 6 is arranged between the ring 5 and the radiating element(s) to isolate the radiating element(s) and the ring 5 from each other. In the examples shown in FIGS. 1a-3b the ring 5 and the non-conducting gap 6 are arranged on a third surface area 15 of the support structure 1. The third surface area (which could also be called a top surface area) surrounds the hollow area 1) and extends in an orthogonal direction compared to an extension direction of the wall 13 between the foot 11 and the top 12. Furthermore, the third surface area 15 has a larger outer circumference than the wall 13. In this preferred embodiments also the first metallization 2 and the slots 41-44 further extend along the third surface area 15. According to further embodiments, the first metallization and the slots 41-44 only extend along the first surface area 131 (the inner side of the wall 13).

Although, in the shown embodiments, the radiating elements 21-22 are arranged on the inner surface area 131 of the support structure 1 and the feeding circuits 31-32 are arranged on the outer surface area 132 of the support structure 1, in further embodiments, the radiating elements 21-23 can also be arranged on an outer surface area 132 of the support structure 1 and the feeding circuits 31-32 can be arranged on an inner surface area 131 of the support structure 1.

Furthermore, and as already mentioned above the support structure 1 further comprises the third surface area 15 (a top surface area) surrounding the hollow area 14 and extending in an orthogonal direction compared to an extension direction of the wall 13 between the foot 11 and the top 12, the first metallization 2 (and with it the radiating elements 21-22) further extend(s) along the third surface area 15. The third surface area 15 has a larger outer circumference than the wall 13. In further embodiments, such top surface area 15 may not exist and/or the first metallization 2 is only arranged at the wall 13.

Furthermore, in the embodiments shown in FIGS. 1a-3b on the first surface area between the slots 41-44 in the first metallization 2, further non-conducting areas 20 are arranged. By this feature it can be achieved that metal material is saved but the radiating properties of the antenna element are not adversely effected.

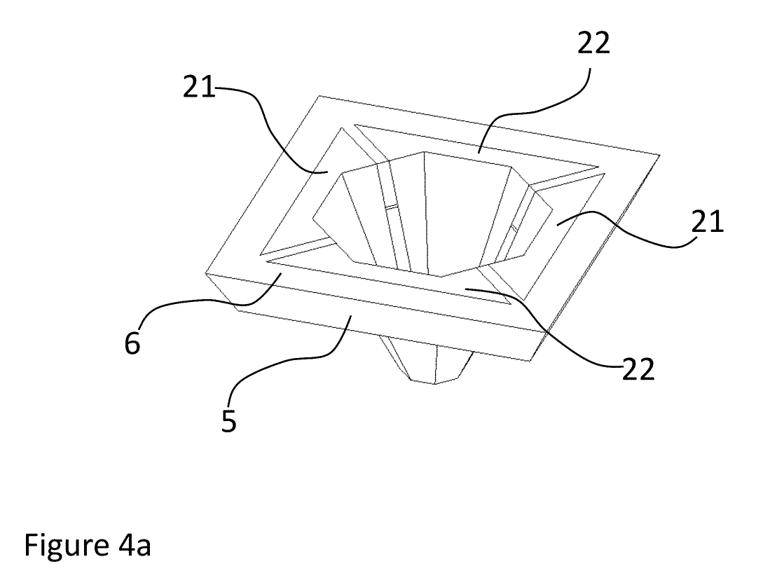

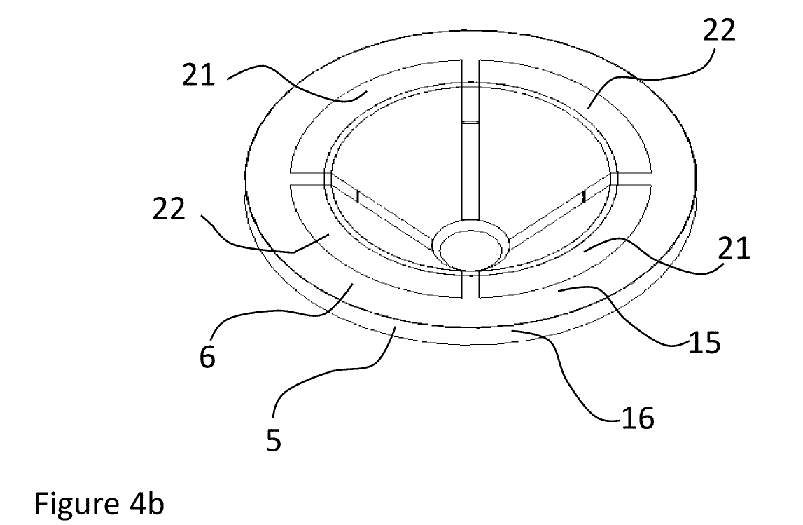

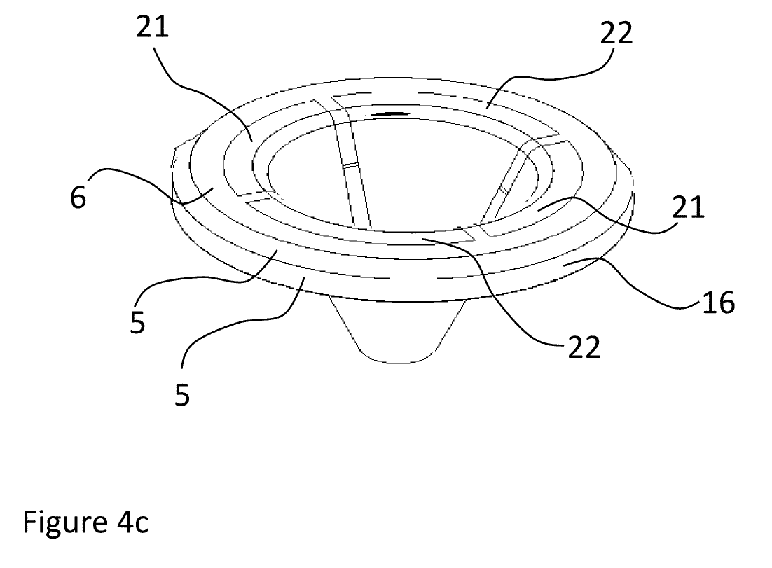

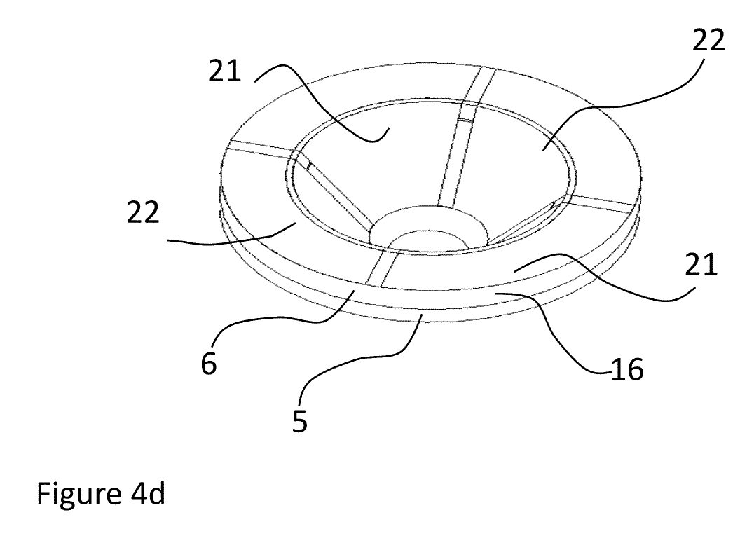

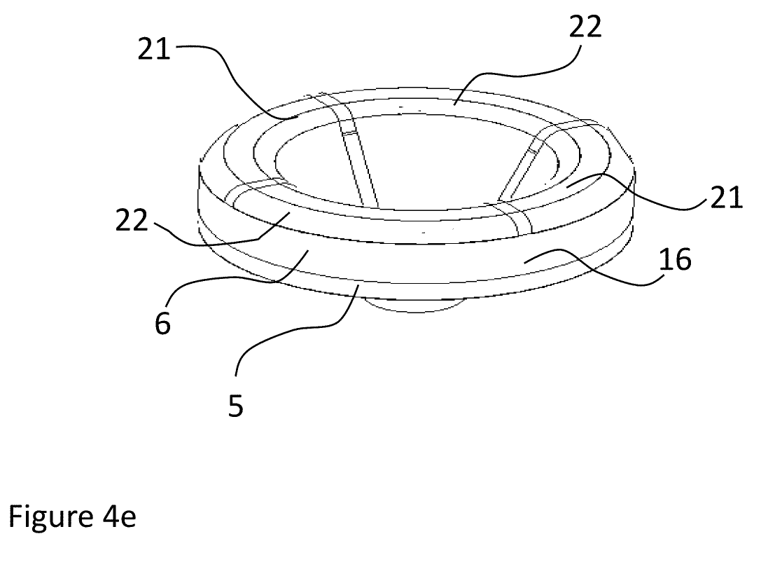

In further embodiments (e.g. as shown in FIGS. 4a to 4e) on the first surface area 131 between the slots 41-44 in the first metallization 2, the first metallization 2 is continuous. It should be understood that also the embodiments as shown in FIGS. 1a to 3b may be altered to have a continuous first metallization 2.

Furthermore, several additional electrical features can be integrated on the antenna element (also designated as one part squared dipole) as described in the following:

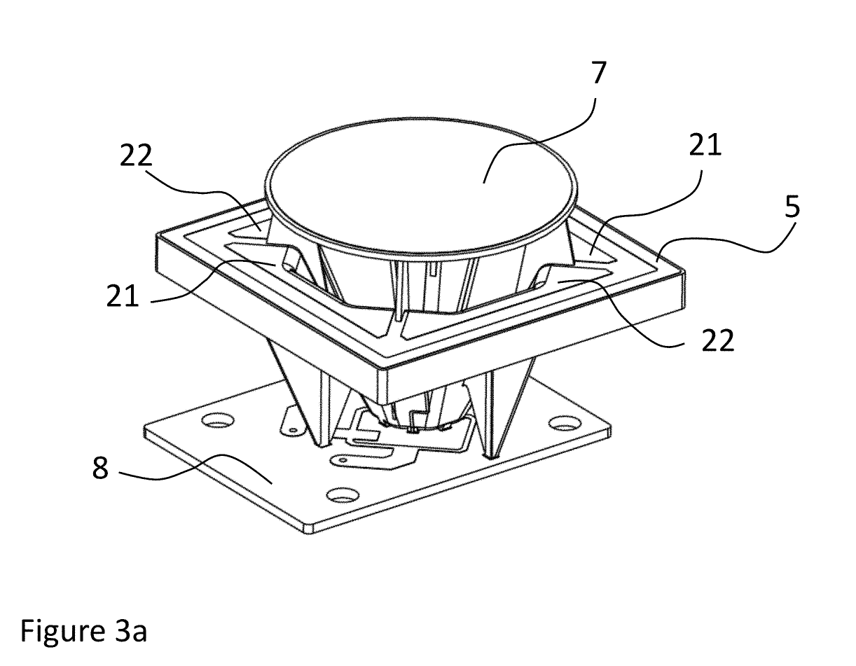

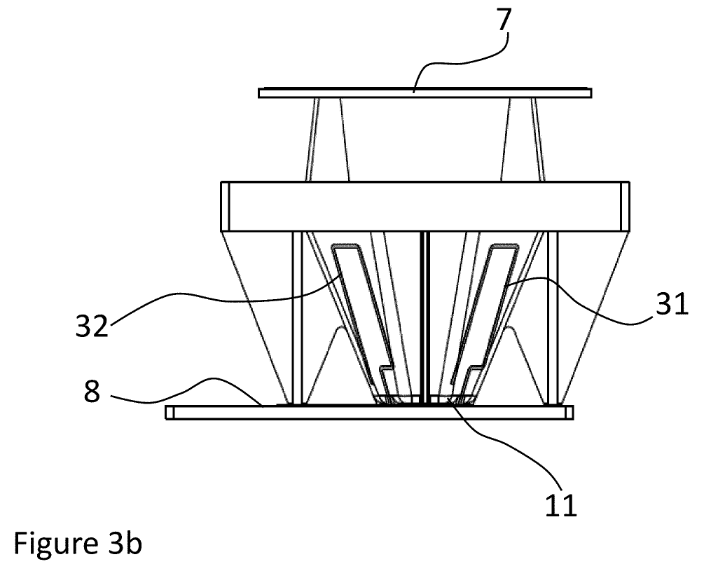

FIG. 3 shows a further possible radiator (or antenna element) design according to an embodiment of the present invention. It comprises one plastic part with the squared dipole including a parasitic ring 5 and four microstrip lines in forms of baluns 31-34 (only baluns 31 and 32 are shown in FIG. 3b) metallized onto the support structure 1 (which can be as already mentioned before a plastic part). The radiating elements 21-22 (in this case two cross polarized dipoles forming a squared dipole) and parasitic ring 5 are located on the inner surface area (at the wall 13) and top surface area (at the top 12) of the plastic part, respectively. The baluns (the feeding circuit) and contacts pads for PCB 8 connection are located on the outer surface area (on the wall 13) and a bottom surface area (at the foot 11) of the plastic part 1. The ring 5 can have different positions relative to the radiator ends, it can be 3D-shaped, on different vertical positions and on different horizontal positions. Also, the angle relative to the support structure 1 can vary.

Some examples of the ring 5 are shown in FIGS. 4a-4e. The antenna element in FIG. 4a has a square top surface 15 and a slant ring 5. The antenna element in FIG. 4b has a horizontal gap 6. The antenna element in FIG. 4c has a horizontal gap 6 and rounded edges. The antenna element in FIG. 4d has a vertical gap 6. The antenna element in FIG. 4e has a vertical gap 6 and rounded edge(s). Different shapes of the parasitic ring 5 bring different tunings. The vertical position results in a better isolation between the ports, compared to the horizontal placement. With MID, it is possible to make the 3D-shape ring 5 from manufacturing process point of view.

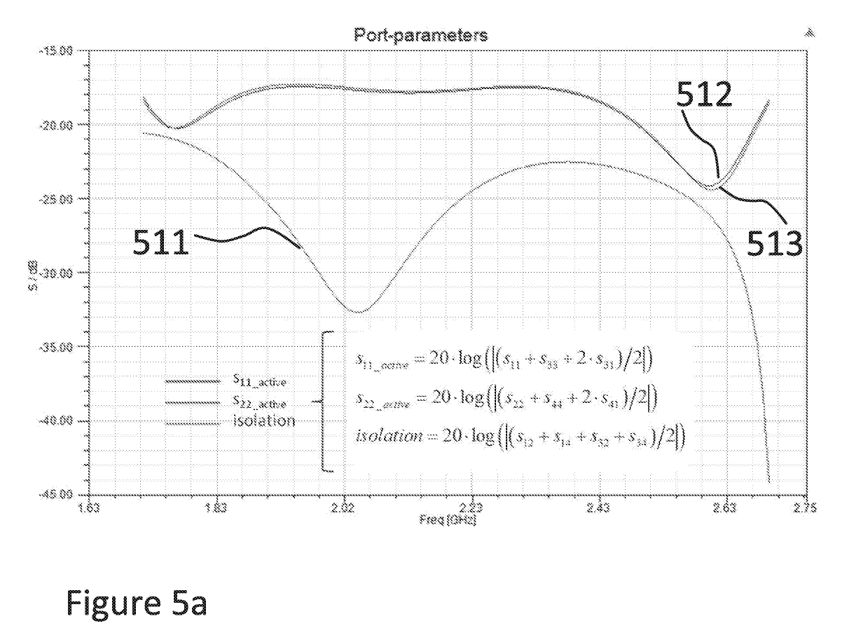

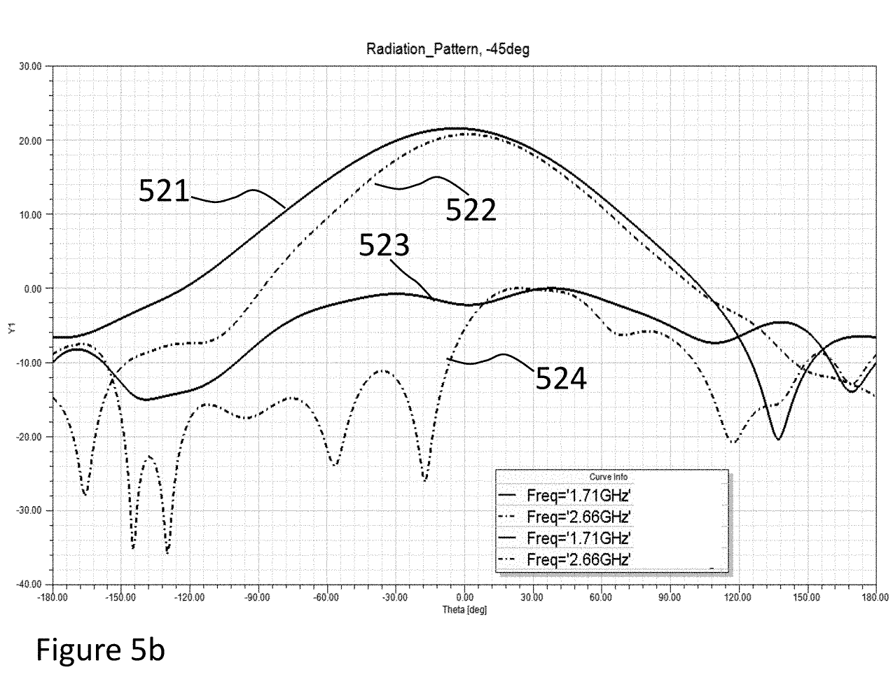

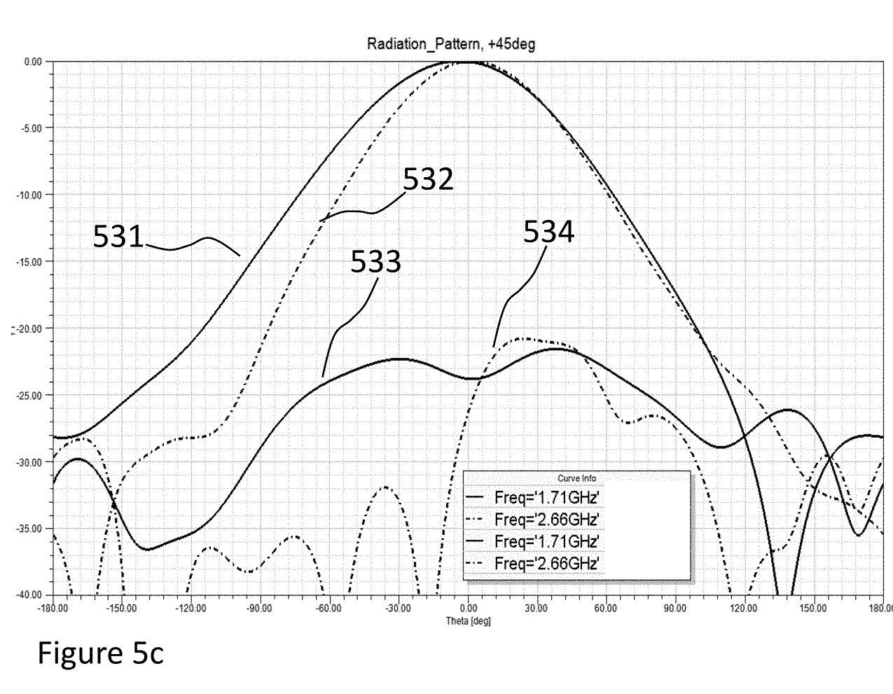

The return loss and radiation pattern of for the embodiment as shown in FIGS. 1a to 1c are presented in FIGS. 5a-5c. FIGS. 5a-5c show a high band implementation covering the frequency range from 1.7 GHz to 2.7 GHz. FIG. 5a shows the return loss and isolation. Curve 511 and curve 512 show the return loss of port 1 and 2, respectively. Curve 513 shows the isolation between the ports. FIG. 5b shows the radiation patterns for the frequencies 1.71 GHz and 2.66 GHz. It is the horizontal cut, co- and cross-polarization for the −45° polarization. Curve 521 shows the co-polar radiation pattern at 1.71 GHz. Curve 522 shows the co-polar radiation pattern at 2.66 GHz. Curve 523 shows the cross-polar radiation pattern at 1.71 GHz. Curve 524 shows the cross-polar radiation pattern at 2.66 GHz. FIG. 5c shows the same for the +45° polarization. Curve 531 shows the co-polar radiation pattern at 1.71 GHz. Curve 532 shows the co-polar radiation pattern at 2.66 GHz. Curve 533 shows the cross-polar radiation pattern at 1.71 GHz. Curve 534 shows the cross-polar radiation pattern at 2.66 GHz. The current design, as an example for a highband implementation, covers a BW of 45%. The height from the top 12 of the radiator to the closest ground plane is 0.3 λ for the lowest frequency.

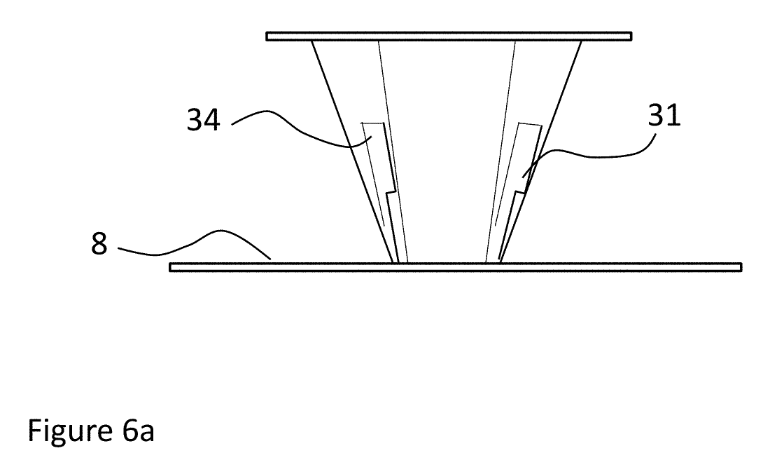

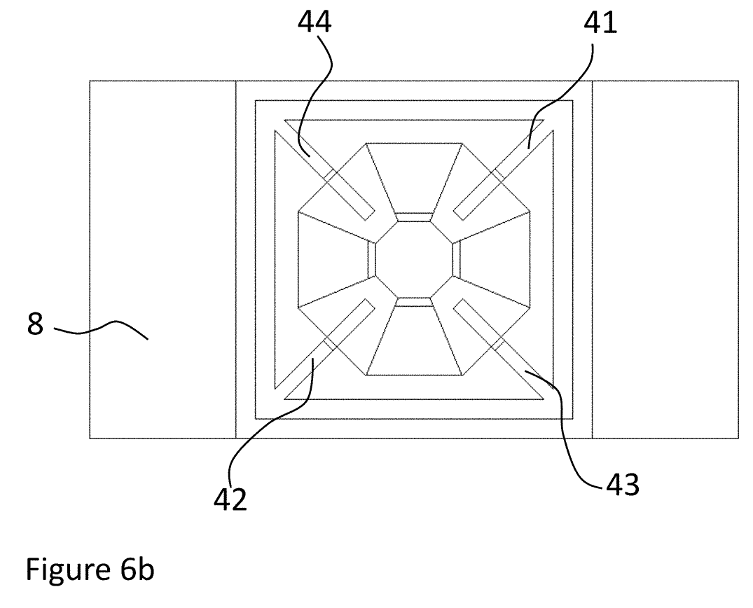

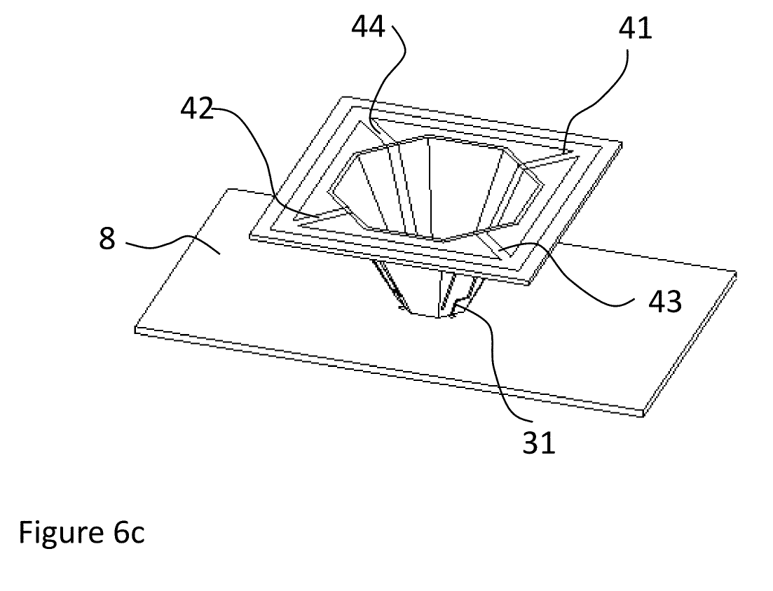

As can be seen in FIGS. 6a-6c, the squared dipole or in more detail the radiating elements 21, 22 can be fed by capacitive coupling across the slots 41-44 by the four baluns 31-34. Two baluns which are respectively positioned on opposite sides on the same (inner or outer) surface area of the antenna element represent the same polarization and have to be combined. In the presented solution, the combining is done on the PCB 8. In this way, the array feeding network which provides signals in the classical ±45 degree configuration can be established. The squared dipole itself or in more detail the first metallization 2 is directly connected to the ground plane of the PCB 8.

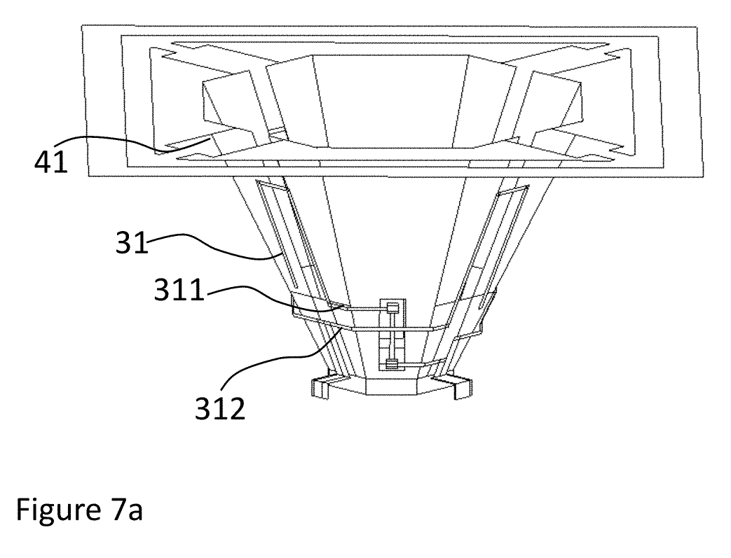

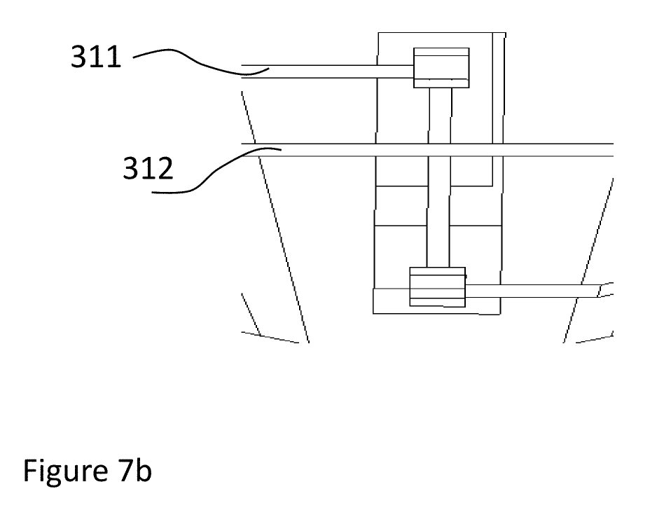

The signal combination can alternatively also be implemented on the plastic part (the support structure 1). In this case, a line crossing occurs. This problem can solved by adding vias in the antenna element (which can be a molded part). FIGS. 7a-7b show a solution with two via holes and a two sided metallization of the feeding network. Generally, the vias can be implemented at any position on the dielectric support structure 1, and the number of vias is variable. On the outer surface area 132 of the support structure 1, a first microstrip line 311 of a feeding circuit crosses the first slot 41 (being arranged on the inner surface area) and a second microstrip line 312 of the feeding circuit crosses the second slot 42 (being arranged on the inner surface area).

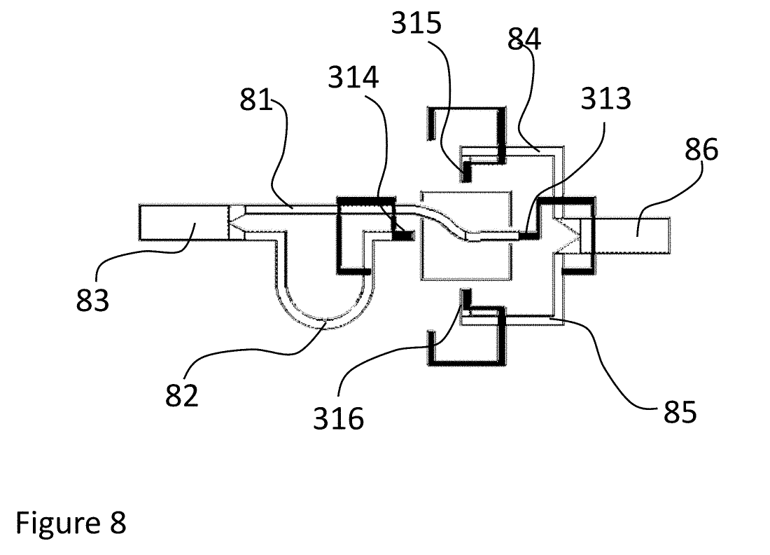

Furthermore, the signal combination can also be part of the PCB 8 at the bottom of the radiator as is shown in FIG. 8. In this case, no crossing is needed on the support structure 1 itself. The PCB 8 comprises feeding lines 81-82 and a power divider 83. The first feeding circuit 31 comprises at the foot 11 of the support structure 1 a first input port 313 connected to the first feeding line 81 and a second input port 314 connected to the second feeding line 82. A length of the first feeding line 81 on the PCB 8 from the power divider 83 to the first input port 313 is equal to a length of the second feeding line 82 on the PCB from the power divider 83 to the second input port 314. Thereby phase variations to different delays can be avoided.

If the antenna element is dual-polarized, the PCB 8 may further comprise feeding lines 84-85 and a power divider 86. The antenna element may further comprise a second feeding circuit including a third input port 315 and a fourth input ports 316 respectively connected to the third feeding line 84 and the fourth feeding line 85. The feeding lines 84-85, the power divider 86 and the input ports 315-316 are arranged the way same as the feeding lines 81-82, the power divider 83 and the input ports 313-314. In other words, also the lengths of feeding lines 84 and 85 are equal to each other.

Furthermore, embodiments of the present invention also allow the integration of a director 7. The director is typically implemented on the top of the support structure 1.

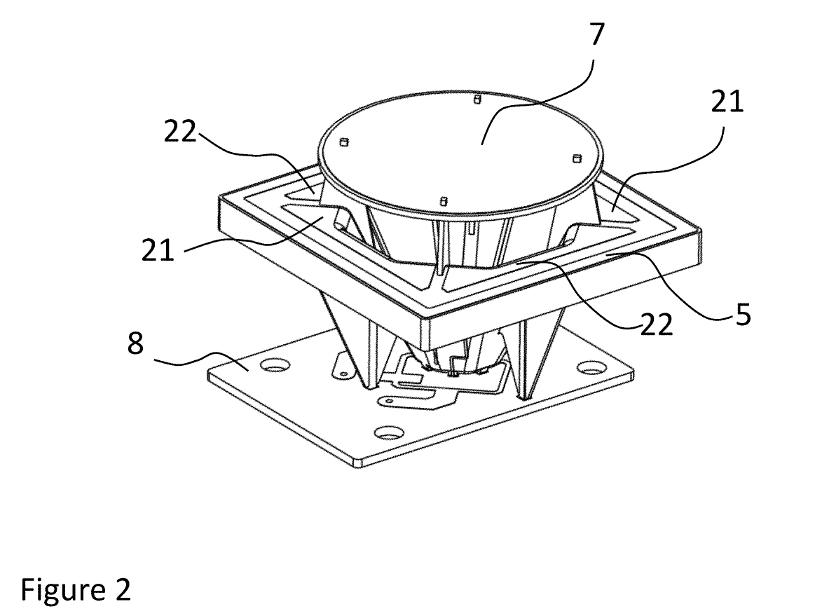

FIG. 2 shows an embodiment where a director support is added to the support structure 1 and the director 7 is formed as a further part arranged on the director support of the support structure.

FIG. 3 shows an embodiment where the director 7 is added in one single part together with the remaining elements of the antenna element. In other words, in this embodiment also the director is an integral part of the support structure. The complete antenna element is therefore a single piece (except the PCB 8 eventually soldered to the foot 11).

The continuous increasing demand of data-traffic challenges the mobile telecommunication industry to introduce new frequency bands, standards and radio access technologies e.g. MIMO, beamforming etc. State of the art macro-cell base station antennas can contain 3 highband and 1 lowband array. Simplifying the assembly of the dipoles by having them made of one part significantly reduces the assembly time in base station antenna production.

Some benefits of embodiments of the present invention are: Cost reduction due to assembly time reduction, a simplified supply chain, improved reliability due to a simplified mechanical design and in case of LDS (Laser direct structuring), one plastic part can be used for several radiators or designs.

1. An antenna element, the antenna element comprising:
a support structure being a single part and comprising a foot, a top and a wall connecting the foot to the top, the wall surrounding a hollow area;
a first metallization arranged on a first surface area of the support structure, the first metallization forming at least a first radiating element extending along the wall from the foot to the top; and
a second metallization arranged on a second surface area of the support structure, the second metallization forming at least a first feeding circuit for the first radiating element; and
wherein the first surface area of the support structure and the second surface area of the support structure are arranged opposite to each other, and wherein either the first surface area or the second surface area is adjacent to the hollow area.

2. The antenna element according to claim 1, further comprising at least a first and a second non-conducting slot on the first surface area in the first metallization, wherein the slots extend in a direction from the foot to the top.

3. The antenna element according to claim 2, wherein the first feeding circuit comprises, on the second surface area, a first microstrip line crossing the first slot and a second microstrip line crossing the second slot.

4. The antenna element according to claim 2, wherein the first metallization is continuous on the first surface area between the slots in the first metallization.

5. The antenna element according to claim 2, wherein at least one non-conducting area is arranged on the first surface area between the slots in the first metallization.

6. The antenna element according to claim 1,
wherein the support structure further comprises a third surface area surrounding the hollow area and extending in an orthogonal direction compared to an extension direction of the wall between the foot and the top; and
wherein the first metallization further extends along the third surface area.

7. The antenna element according to claim 6, wherein the third surface area has a larger outer circumference than the wall.

8. The antenna element according to claim 6 further comprising an electrically closed ring and a non-conducting gap on the support structure, wherein:
the electrically closed ring surrounds the first radiating element; and
the non-conducting gap isolates the first radiating element and the electrically closed ring from each other.

9. The antenna element according to claim 8, wherein the electrically closed ring is arranged on the third surface area.

10. The antenna element according to claim 8, wherein the support structure further comprises a fourth surface area surrounding the hollow area and extending from an edge of the third surface area distant from the wall in an extension direction of the wall between the top and the foot;
wherein the electrically closed ring is arranged either on the fourth surface area or on both the third surface area and the fourth surface area; and
wherein the non-conducting gap is arranged on the third surface area or the fourth surface area.

11. The antenna element according to claim 1, further comprising a director arranged at the top of the support structure.

12. The antenna element according to claim 11, wherein the director and the support structure are formed in a single part.

13. The antenna element according to claim 1, wherein the antenna element is a Molded Interconnect Device (MID).

14. The antenna element according to claim 1 further comprising:
a printed circuit board (PCB), the PCB comprising a first feeding line, a second feeding line, and a power divider,
wherein the first feeding circuit comprises, at the foot of the support structure, a first input port connected to the first feeding line and a second input port connected to the second feeding line; and
wherein a length of the first feeding line on the PCB from the power divider to the first input port is equal to a length of the second feeding line on the PCB from the power divider to the second input port.

15. The antenna element according to claim 1,
wherein the first metallization forms a second radiating element and the second metallization forms a second feeding circuit for the second radiating element; and
wherein the first radiating element has a first polarization and the second radiating element has a second polarization, wherein the first polarization and the second polarization are orthogonal to each other.

16. An antenna element for a base station antenna, the antenna element comprising:
a support structure being a single part and comprising a foot, a top, and a wall connecting the foot to the top, the wall surrounding a hollow area;
a first metallization arranged on a first surface area of the support structure, the first metallization forming at least a first radiating element extending along the wall from the foot to the top; and
a second metallization arranged on a second surface area of the support structure, the second metallization forming at least a first feeding circuit for the first radiating element; and
wherein the first surface area of the support structure and the second surface area of the support structure are arranged opposite to each other, and wherein either the first surface area or the second surface area is adjacent to the hollow area.
